(19) United States
(12) Patent Application Publication
(10) Pub. No.: US 2026/0072799 A1
(43) Pub. Date: Mar. 12, 2026

(54) Agentless Adaptive Service Mapping for Enhanced Observability in Information Systems

(71) Applicant: IT Monitoring Solutions, Trinity, FL (US)

(72) Inventor: Roshan Garib, Trinity, FL (US)

(21) Appl. No.: 19/320,408

(22) Filed: Sep. 5, 2025

Related U.S. Application Data
(60) Provisional application No. 63/691,667, filed on Sep. 6, 2024.

(51) Int. Cl. G06F 11/30; G06F 11/14; G06F 11/32

(52) U.S. Cl. CPC G06F 11/3051; G06F 11/1438; G06F 11/328

(57) ABSTRACT

A method for agentless adaptive service mapping for enhanced observability in information systems is described herein. The method includes executing various commands to access, from computers in a computer network, information regarding selected services executing thereon. The selected services are mapped to their respective applications and versions numbers. This mapping information is stored in a return dataset, and may be accessed through a dashboard display to provide IT personnel information at a glance. The accessing of service information and mappings is carried out without the use of agents that would otherwise be installed on each of the computer systems of the network.

### CROSS-REFERENCE TO RELATED APPLICATIONS

The present application claims priority to and all the benefits of U.S. Provisional Patent Application No. 63/691,667 , filed on Sep. 6, 2024, the entire contents of which are expressly incorporated herein by reference.

### FIELD OF THE INVENTION

This disclosure is directed to computer systems, and more particularly, to the observability of services running on computer systems in, e.g., enterprise systems/networks.

### DESCRIPTION OF THE RELATED ART

Institutional computer systems and networks may operate a variety of different types of application software. Some of these software applications may be run organization-wide, while others may be specific to a particular department. For example, a hospital might use certain applications that are used by all departments therein, while some departments may also run applications that are specific to their needs. Thus, a wing of a hospital dedicated to performing surgical procedures may have one set of applications that are unique thereto, while a rehabilitation wing may have a second set of unique applications, a neurology wing may have a third set of unique applications, and so on.

Each of the various types of applications may utilize one or more services that are specific thereto. These services may perform functions such as managing hardware resources of the various computer systems upon which they are operating, and may further provide certain types of functionality within the application. Some services may be critical to the operation of a given application, while other services, while useful, are not critical.

The present invention addresses one or more of the aforementioned challenges.

### SUMMARY OF THE INVENTION

In one aspect of the present invention, a method of operating a network computer system is provided. The method includes causing, by a first computer system, execution of a plurality of commands to access one or more additional computer systems, and determining, in response to executing the commands, selected services executing on each of one or more additional computer systems coupled, via a network, to the first computer system. The selected services are accessed on a given one of the one or more additional computer systems without utilizing an agent executing on the given one of the one or more additional computer systems. The method includes mapping each of the selected services to a corresponding one of a plurality of applications and a version number of the corresponding one of the plurality of applications, updating, on the first computer system, a return data file having a plurality of entries, and displaying information from one or more entries of the return data file. Entries of the return data file include identification of one of the selected services, a one of the one or more additional computers systems upon which the one of the selected services are executing, and a one of the plurality of applications and version number associated with the one of the selected services.

In another aspect of the present invention, a non-transitory computer readable medium storing instructions thereon is provided. When executed by a first computer system, instructions cause the first computer system to carry out operations including executing a plurality of commands to access one or more additional computer systems and determining, in response to executing the commands, selected services executing on each of one or more additional computer systems coupled, via a network, to the first computer system. The selected services are accessed on a given one of the one or more additional computer systems without utilizing an agent executing on the given one of the one or more additional computer systems. The first computer system then maps each of the selected services to a corresponding one of a plurality of applications and a version number of the corresponding one of the plurality of applications, updates a return data file having a plurality of entries, and displays, on a dashboard, information from one or more of the entries of the return data file. Entries of the return data file include identification of one of the selected services, a one of the one or more additional computers systems upon which the one of the selected services are executing, and a one of the plurality of applications and version number associated with the one of the selected services.

In yet another aspect of the present invention, a networked computer system is provided. The network computer system includes a plurality of services computer systems executing a plurality of applications running a plurality of computer services and a monitoring computer system including a display device including a graphical user interface (GUI) and one or more processors coupled to each services computer system. The one or more processors of the monitoring computer system are programmed to execute an algorithm including the steps of accessing each services computer system and determining selected services executing on each services computer system. The selected services are accessed on a corresponding services computer system without utilizing an agent executing on the corresponding services computer system. The monitoring computer system then maps each of the selected services to a corresponding one of a plurality of applications and a version number of the corresponding one of the plurality of applications, and updates a return data file stored on the monitoring computer system and having a plurality of entries. The entries of the return data file include identification of one of the selected services, a one of the services computer systems upon which the one of the selected services are executing, and a one of the plurality of applications and version number associated with the one of the selected services. The monitoring computer system then renders a monitoring dashboard on the monitoring computer system GUI displaying a number of user selectable application icons arranged in a grid, with each application icon representing an application running on the plurality of services computer systems.

In a further aspect of the present invention, a method for agentless adaptive service mapping for enhanced observability in information systems is provided. The method includes executing, on a first computer system, a plurality of commands to access one or more additional computer systems. The method further includes determining, in response to executing the commands, selected services executing on each of one or more additional computer systems coupled, via a network or via a cloud-based system, to the first computer system, wherein the selected services are accessed on a given one of the one or more additional computer systems without utilizing an agent executing on the given one of the one or more additional computer systems. The method further includes mapping each of the selected services to a corresponding one of a plurality of applications and a version number of the corresponding one of the plurality of applications. Based on the mapping, the method includes updating, on the first computer system, a data result set (or data file). The information from the data file may be integrated with various observability tools, and may also be stored in a database having a plurality of entries, a given entry storing information regarding the identification of one of the selected services, a one of the one or more additional computers systems upon which the one of the selected services are executing, and a one of the plurality of applications and version number associated with the one of the selected services. The method also includes displaying, on a dashboard, information from one or more of the plurality of entries of the database or data file.

### BRIEF DESCRIPTION OF DRAWINGS

The above and/or other aspects will become apparent and more readily appreciated from the following description of example embodiments, taken in conjunction with the accompanying drawings, in which:

FIGS. 1A-1C illustrate operations carried out in one embodiment of a method for monitoring services on a server system;

FIG. 2 illustrates one embodiment of a network and computer system for monitoring the network;

FIG. 3 illustrates one embodiment of a dashboard display for one embodiment of a monitoring system; and

FIG. 4 illustrates one embodiment of an algorithm method for monitoring services executing on one or more computer systems.

Corresponding reference characters indicate corresponding parts throughout the drawings.

### DETAILED DESCRIPTION OF EMBODIMENTS

Reference will now be made in detail to example embodiments which are illustrated in the accompanying drawings, wherein like reference numerals refer to like elements throughout. In this regard, the example embodiments may have different forms and may not be construed as being limited to the descriptions set forth herein.

It will be understood that the terms “include,” “including,” “comprise,” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be further understood that, although the terms “first,” “second,” “third,” etc., may be used herein to describe various elements, components, regions, layers and/or sections, these elements, components, regions, layers and/or sections may not be limited by these terms. These terms are only used to distinguish one element, component, region, layer or section from another element, component, region, layer or section.

As used herein, the term “and/or” includes any and all combinations of one or more of the associated listed items. Expressions such as “at least one of,” when preceding a list of elements, modify the entire list of elements and do not modify the individual elements of the list.

Various terms are used to refer to particular system components. Different companies may refer to a component by different names—this document does not intend to distinguish between components that differ in name but not function.

Matters of these example embodiments that are obvious to those of ordinary skill in the technical field to which these example embodiments pertain may not be described herein in detail.

In organizations of various sizes, information technology (IT) systems are an important component of their respective operations. Such IT systems typically include a number of computers coupled to one another to form a network, the computers including both server systems as well as end-user systems. These computers may run a wide variety of different applications to support the operations of the organization. Some of these applications may be run throughout an organization, while other applications may be run primarily on computers in specific departments. For example, in a hospital setting, email and timekeeping applications can be run on computers in all departments. Meanwhile, departments within the hospital, such as a surgical wing, a rehabilitation wing, a neurology wing, a pediatric wing, and a cardiology wing may all run applications that are specific to their respective operations. Furthermore, some applications may be run in multiple (but not all) departments when their respective operations overlap. Many of these applications running on the various computer systems may be critical with respect to the operations performed in the hospital and its various departments.

A given application running on various computer systems may utilize a number of different services to perform different tasks associated with its operations. Such services can include operating system services, web services, network services, and numerous application specific services, among others. Some of these services may be critical to the operation of a given application, meaning the application cannot operate without them. Other services may be such that, in the event they stop operating, the application may nevertheless continue operating with reduced functionality.

IT departments in large organizations may from time to time need to know which applications, and thus which critical services, are operating on each of the organization's computers. Such information may be needed during system outages due to, e.g., a malicious attack from a third party, an interruption of power, and so on. Timely restoration of system operation may be dependent on, at least in part, knowledge of which critical services need to be operating on which computers. However, such information is not always readily available, thereby complicating efforts to restore system operation.

One mechanism to monitor a system (and computers thereon) for services to support various mission critical applications is the deployment of agents. An agent as defined herein is a software application that is installed on a computer system that can monitor the applications run thereon and the corresponding services and to communicate this information to a third party computer (e.g., operated by IT personnel within or without of the corresponding organization). To get an accurate assessment of services running on each computer within an organization, each must have the agent installed and running thereon. This may be a time consuming process, requiring personnel to perform the installation and upkeep on each of the organization's computer systems. Furthermore, the operation of the agent may consume some system resources, such as memory and network bandwidth.

The present disclosure is directed to systems and methods for performing agentless monitoring of computer systems within an organization. One embodiment includes the execution of commands to query the various computer system of an organization. The commands may be executed on a third party computer system(s), or may be sent from the third party computer systems to be executed on the various computer system(s) subject to monitoring. In response to execution of the commands, applications and corresponding services running on a monitored computer system are determined. These services are mapped to the application, the vendor of the application, and a version number, service description, service name, and so on. The services that are mapped are, in one embodiment, critical services, although embodiments in which all services are mapped are also possible and contemplated. The script/app causing the execution of the commands may read status of the service if its running and if it is configured for automatic startup, Mapped information, including the service, its corresponding application, version information, and computer system in which it is executing, is then sent to a stored data result file or database (which may be located on or coupled to the third party computer system from which the commands originated) and stored in corresponding entries. Information from the data result file or database may be displayed on a dashboard.

The dashboard display may provide IT personnel with quick, streamlined access to information regarding the services operating on the various computer systems of the organization. Using the dashboard, IT personnel may attempt to restart services during downtime incidents. Furthermore, the dashboard may enable IT personnel to more quickly analyze which services are down for a number of computer systems within an organization. This in turn may allow for more rapid troubleshooting and restoration of normal operation. Furthermore, utilizing the dashboard and information displayed thereon may allow IT personnel enhanced observability to manage and maintain the IT systems within an organization to prevent future incidents of downtime and thereby increase overall reliability. Various embodiments of systems and methods in accordance with the present disclosure are now described in further detail.

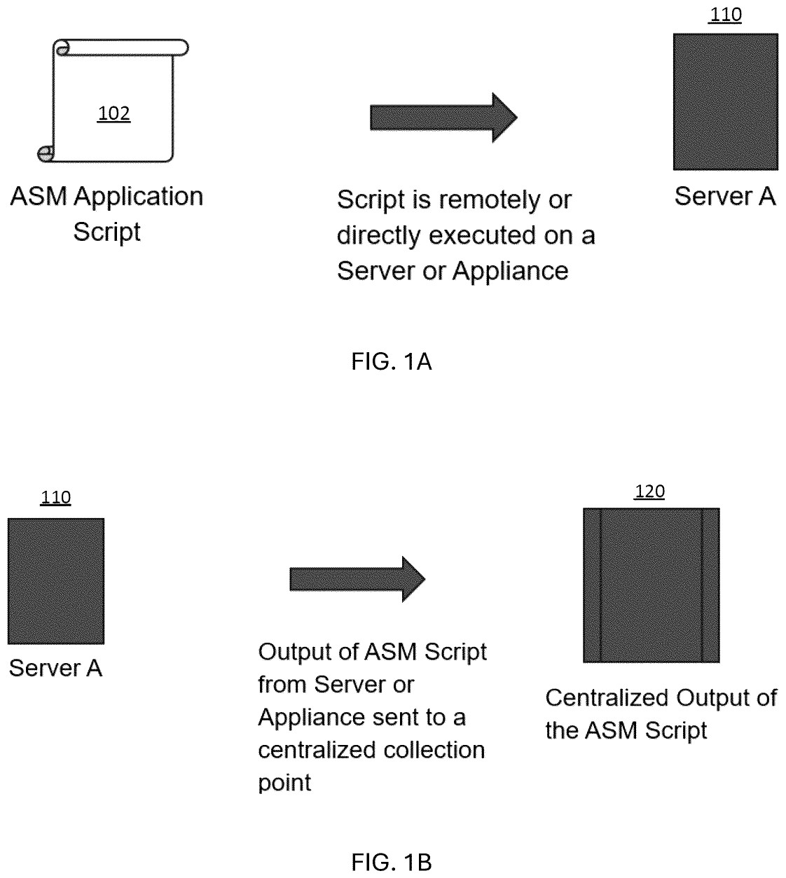

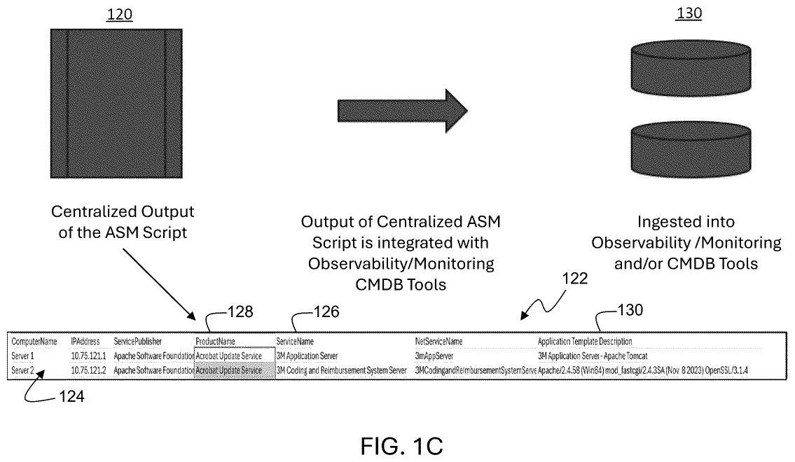

FIGS. 1A-1C illustrate operations carried out in one embodiment of a method for monitoring services on a server system. As shown in FIG. 1A, a script or an application (e.g., an executable file) is executed on a computer system 102. The script may cause the generation of a number of different commands. These commands may also be executed (remotely) on computer system 102, or may be conveyed to server 110 and executed directly thereon.

In response to execution of the commands, a determination is carried out regarding the various services executing on server 110. In some embodiments, this includes determining all services running on server 110. In other embodiments, execution of the commands results in a determination of the running of selected services, such as those deemed critical to a particular application. In some embodiments, a determination may be carried out to determine all services for applications deemed critical. The criticality of an application may be determined by, e.g., user input, a table/list, or any other suitable mechanism. The criticality of a service associated with the application may be determined by one or more parameters associated therewith, such as whether the services is configured to automatically start on a system boot, automatically restart if the service stops running, and so on.

The execution of the commands then causes the selected services to be mapped to other pieces of information, including their respective application and version number. The mappings of services to their respective computer system, application, and version number are then send, in accordance with FIG. 1B, to a centralized output location 120. In some embodiments, the centralized output location 120 may be a part of computer system 102, although this location can be on another system in other embodiments. Per FIG. 1C, the mappings are then stored into a result set like a data file 122. Entries for an example implementation of such a data file are shown at the bottom of the drawing. The results stored into the data file may further be stored in a database, such as a centralized monitoring database (CMDB). In one embodiment, the file and/or database in which information from the file is stored may include a number of entries that includes the mappings of services to a corresponding computer system, application, and version number. At least a subset of the entries of the file or database may be reserved for this information, although in various embodiments, including the CMDB embodiments, other entries may be reserved for other types of information. The mapping information from the data file may also be integrated for use with IT observability tools used to monitor information system networks in an organization/enterprise, as well as for alerting personnel to problems within the network, and for visualizing the network status.

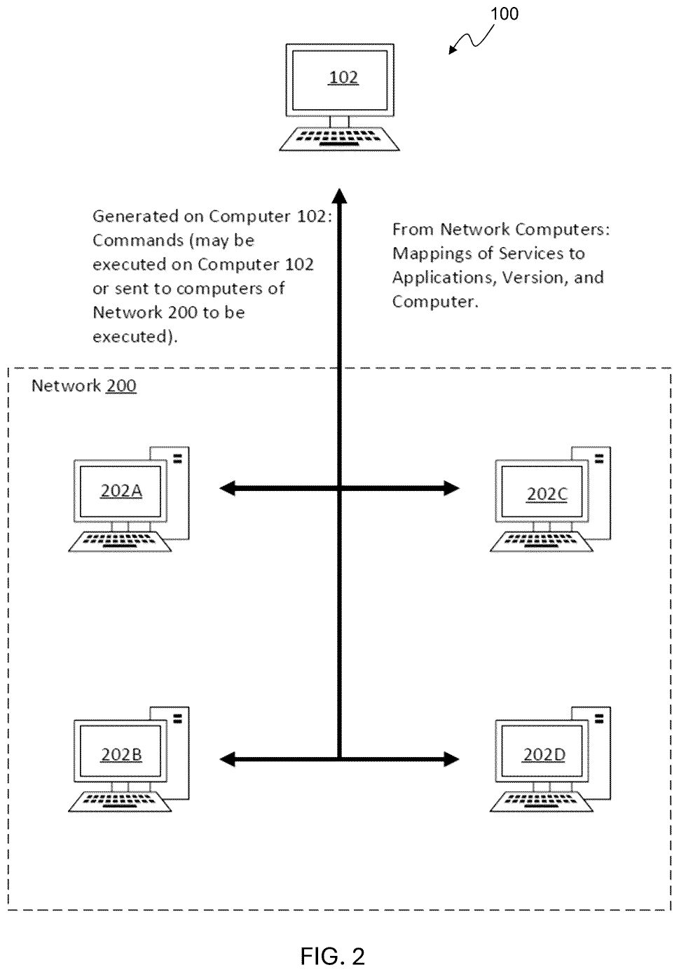

FIG. 2 illustrates one example of a networked computer system 100 including a network 200 and computer system 102 for monitoring the network 200. In the embodiment shown, computer system 102 is connected to computers 202A-202D of network 200. Computer 102 may, in some embodiments, be on-sight (e.g., co-located with) the computers of network 200. In other embodiments, computer 102 may be located remotely with respect to computers 202A-202D. It is further noted that the various computers of network 200 may reside in different locations, e.g., such as in an example when network 200 is part of the IT infrastructure for a nationwide enterprise with operations in different locations. It is further noted that while network 200 includes four computers in this example, this numbers is not intended to be limiting and is shown here for the sake of illustration.

Computer 102 in the embodiment shown may be used to generate commands from, e.g., a script or an application, to query the computers of network 200 with regard to the various services executing thereon. In some embodiments, the commands may be executed on computer 102 itself, with these commands causing the queries of the various computers of network 200 to be carried out. In other embodiments, at least some of the commands may be sent to and executed on the various ones of computers 202A-202D.

Execution of the commands results in a determination of selected services executed on the various computers of network 200, along with mappings of those services to their respective applications, version number of the application, and the computer system on which they are being executed. This may be carried out on each of computers 202A-202D. Thereafter, these computers may send the mapping information back to computer 102, which may serve as a centralized output location. It is noted that in other embodiments, this information may be sent to another computer system for aggregation. In various embodiments, computer 102 (or other location in which the mapping data is aggregated) may also include the database in which the mappings are stored.

It is noted that the execution of the commands is carried out without utilizing agents executing on each of computer system 202A-202D. Accordingly, the method of obtaining the mapping information of the present disclosure is less intrusive and does not significantly impact the operation of these computers.

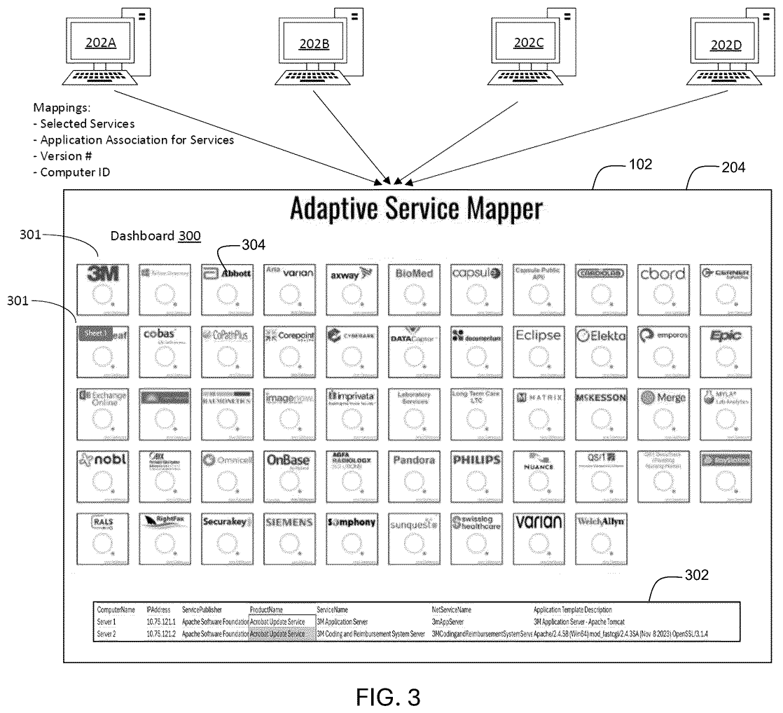

FIG. 3 illustrates one embodiment of a dashboard display for one embodiment of a monitoring system. Dashboard 300 in the embodiment shown represents one possible user interface that may be displayed on, e.g., computer system 102 to provide observability to IT personnel regarding services executing on computers of an organization's network and their respective mappings.

In the illustrated example, dashboard 300 includes a number of icons 301 arranged in a grid. Each of the icons represents an application running on a computer in a network of the organization. Selection of one of the icons may cause the various mappings to be displayed in a sub-display. More particularly, selecting a particular icon may cause to be displayed the services associated with the application (all services in some embodiments, selected services in others), the version number of the application, computers on the network that are running the application/services, and status of the service on each computer (e.g.., operating normally, not currently running). In various embodiments, the user interface may also enable IT personnel to attempt to restart services that are not currently running but are otherwise required to support operation of their respective application.

The user interface shown here and its additional screens may provide enhanced observability of the status of a network, both in terms of its overall status as well as that of individual network computers. This may enable quicker troubleshooting of network-wide issues during a system outage, as well as that for individual computer systems on the network. Furthermore, the ability provided by the dashboard and various sub-displays may further allow IT personnel to anticipate and prevent network issues that could lead to downtime. For example, in various embodiments, information regarding the performance of particular services may be obtained (e.g., through the execution of the commands discussed above), which may be useful in highlighting issues that can occur on particular computer systems or within the network/enterprise as a whole.

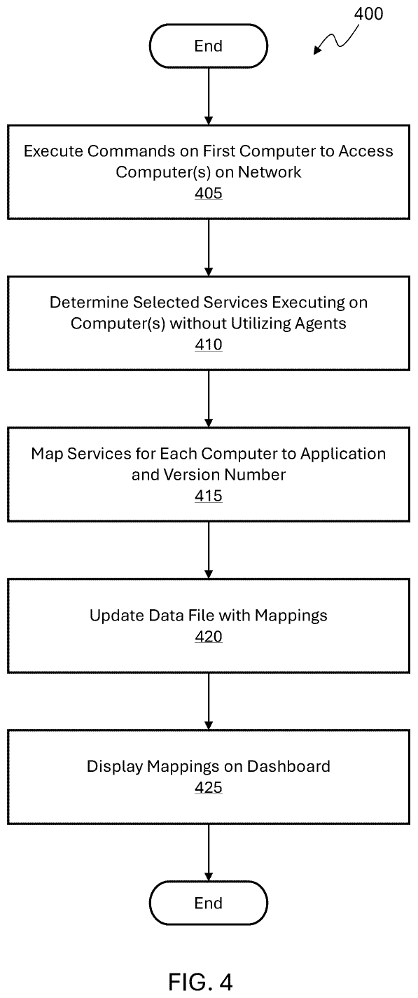

FIG. 4 illustrates one embodiment of an algorithm method for monitoring services executing on one or more computer systems. Algorithm 400 includes the execution of commands on a first computer to access one or more other computers on a network (block 405). In various embodiments, the first computer may be co-located with the computers on the network. In other embodiments, the first computer may be located remotely with respect to at least some of the computers on the network.

It is noted, per various embodiments described above, the commands may be executed on the actual computers of the network instead of the first computer, with the latter tasked with generating and conveying the commands to their respective targets.

Algorithm 400 further includes determining selected services executing on the network without the utilization of agents (block 410). As previously noted, an agent is defined herein as a software application installed on a computer system that monitors the applications run thereon and the corresponding services and to communicate this information to the first computer (e.g., operated by IT personnel within or without of the corresponding organization). The monitored applications may be based on a list of applications provided by user input, or applications selected after a query of the various computers connected to the network. The selected services may be those that are deemed critical for operation of their corresponding applications (e.g., the application cannot function properly unless that service is also functioning correctly). The selected services may be determined based on various parameters, such as if a service is always running when the application is running, if the service is configured to automatically start during a system boot, whether the service is configured to automatically re-start in the event it stops running, and so on. Generally speaking, any suitable mechanism for determining the criticality of a particular service may be utilized by various implementations disclosed herein.

After determining the selected services, Algorithm 400 further includes mapping the services for each computer system to their respective applications and version numbers (block 415). Additional information may also be mapped, such as the interactions of a selected service with other services and/or other applications (e.g., an operating system). The mappings may then be provided to a computer (such as the first computer) in order to update a return dataset or database (block 420).

The mapping information from the return dataset or database may be displayed on a dashboard display (block 425), such as that shown above with respect to FIG. 3. The dashboard display may provide IT personnel with enhanced observability of the services operating on various computer systems of a corresponding network. In addition to the mapping information, other information, such as uptime/downtime for a particular service on a particular computer system and/or its current status may be accessed via the dashboard display.

In some embodiments, the networked computer system 100 includes the plurality of services computer systems 202A-202D executing a plurality of applications running a plurality of computer services; and the monitoring computer system 102 including a display device 204 including a graphical user interface (GUI) for displaying computer generated images thereon and one or more processors coupled to each services computer system 202A-202D. The one or more processors of the monitoring computer system 102 are programmed to execute the algorithm 400 including the steps of accessing each services computer system 202A-202D and determining selected services executing on each services computer system 202A-202D and mapping each of the selected services to a corresponding one of a plurality of applications and a version number of the corresponding one of the plurality of applications. The selected services are accessed on a corresponding services computer system 202A-202D without utilizing an agent executing on the corresponding services computer system 202A-202D.

The one or more processors then updates the return data file 122 stored on the monitoring computer system 102 and having a plurality of entries 124 that include identification of one of the selected services 126, a one of the services computer systems 202A-202D upon which the one of the selected services are executing, and a one of the plurality of applications 128 and version number 130 associated with the one of the selected services 126.

The one or more processors of the monitoring computer system 102 then render the monitoring dashboard 300 on the monitoring computer system GUI 204 displaying a number of user selectable application icons 301 arranged in a grid with each application icon representing an application running on the plurality of services computer systems 202A-202D.

The one or more processors of the monitoring computer system 102 may also be programmed to receive a user selection of one of the application icon 301 associated with a corresponding application via the GUI 204 and responsively animate the GUI 204 to display an information icon 302 indicating the corresponding service 126 associated with the corresponding application 128, a version number 130 of the corresponding application, corresponding services computer systems 202A-202D running the corresponding application, and status of the corresponding service on each of the corresponding services computer system indicating a current operation of the corresponding service. For example, the status of the corresponding service may indicate if the corresponding service is running and if the corresponding service is configured for automatic startup. In some embodiments, the one or more processors of the monitoring computer system 102 may be programmed to receive a user selection of an application icon 301 indicating the corresponding service is not running and responsively transmit a restart signal to the corresponding services computer system 202A-202D running the corresponding application.

The one or more processors of the monitoring computer system 102 may also be programmed to map each of the selected services to a vendor for the corresponding one of the plurality of applications and display each user selectable application icon 301 with an image of the vendor 304.

The one or more processors of the monitoring computer system 102 may also render the monitoring dashboard 300 to display user selectable application icons 301 associated with the services included in a listing of services designated as critical services stored in the return data file 122.

The one or more processors of the monitoring computer system 102 may also query one or more directories of each services computer system to determine respective IP address locations of the selected services, and updating corresponding entries in the return data file 122 to include the respective IP address locations.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible media of expression having computer-usable program code embodied in the media.

Any combination of one or more computer-usable or computer-readable media (or medium) may be utilized. For example, a computer-readable media may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present invention may be written in any combination of one or more programming languages.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

The flowchart and block diagrams in the flow diagrams illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable media that can direct a computer or other programmable data processing apparatus to function in a particular manner, such that the instructions stored in the computer-readable media produce an article of manufacture including instruction means which implement the function/act specified in the flowchart and/or block diagram block or blocks.

Several (or different) elements discussed herein, and/or claimed, are described as being “coupled”, “in communication with”, or “configured to be in communication with”. This terminology is intended to be non-limiting, and where appropriate, be interpreted to include without limitation, wired and wireless communication using any one or a plurality of a suitable protocols, as well as communication methods that are constantly maintained, are made on a periodic basis, and/or made or initiated on an as needed basis. The term “coupled” means any suitable communications link, including but not limited to the Internet, a LAN, a cellular network, or any suitable communications link. The communications link may include one or more of a wired and wireless connection and may be always connected, connected on a periodic basis, and/or connected on an as needed basis.

A controller, computing device, server or computer, such as described herein, includes at least one or more processors or processing units and a system memory (see above). The controller typically also includes at least some form of computer readable media. By way of example and not limitation, computer readable media may include computer storage media and communication media. Computer storage media may include volatile and nonvolatile, removable and non-removable media implemented in any method or technology that enables storage of information, such as computer readable instructions, data structures, program modules, or other data. Communication media typically embody computer readable instructions, data structures, program modules, or other data in a modulated data signal such as a carrier wave or other transport mechanism and include any information delivery media. Those skilled in the art should be familiar with the modulated data signal, which has one or more of its characteristics set or changed in such a manner as to encode information in the signal. Combinations of any of the above are also included within the scope of computer readable media.

The order of execution or performance of the operations in the embodiments of the invention illustrated and described herein is not essential, unless otherwise specified. That is, the operations described herein may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

In some embodiments, a processor, as described herein, includes any programmable system including systems and microcontrollers, reduced instruction set circuits (RISC), application specific integrated circuits (ASIC), programmable logic circuits (PLC), and any other circuit or processor capable of executing the functions described herein. The above examples are exemplary only, and thus are not intended to limit in any way the definition and/or meaning of the term processor.

Generally the tools described herein and the information displayed based on the execution thereof may allow for quick aggregation of information regarding services executing or executable on computer systems of a network, particularly for those that are essential to mission-critical applications. This in turn may allow for faster diagnosis of network issues as well as quicker resolution thereof, leading to less down time. Furthermore, some embodiments may display performance metric information with respect to the selected services, which may be useful in anticipating and preventing problems that could otherwise lead to system downtime or reduced system performance.

It may be understood that the example embodiments described herein may be considered in a descriptive sense only and not for purposes of limitation. Descriptions of features or aspects within each example embodiment may be considered as available for other similar features or aspects in other example embodiments.

While example embodiments have been described with reference to the figures, it will be understood by those of ordinary skill in the art that various changes in form and details may be made therein without departing from the spirit and scope as defined by the following claims.

What is claimed is:

1. A method of operating a network computer system, comprising:
causing, by a first computer system, execution of a plurality of commands to access one or more additional computer systems;
determining, in response to executing the commands, selected services executing on each of one or more additional computer systems coupled, via a network, to the first computer system, wherein the selected services are accessed on a given one of the one or more additional computer systems without utilizing an agent executing on the given one of the one or more additional computer systems;
mapping each of the selected services to a corresponding one of a plurality of applications and a version number of the corresponding one of the plurality of applications;
updating, on the first computer system, a return data file having a plurality of entries, wherein entries of the return data file include identification of one of the selected services, a one of the one or more additional computers systems upon which the one of the selected services are executing, and a one of the plurality of applications and version number associated with the one of the selected services; and
displaying information from one or more entries of the return data file.

2. The method of claim 1, wherein executing the plurality of commands comprises executing a script on the first computer system.

3. The method of claim 1, wherein the mapping further comprises mapping each of the selected services to a vendor for the corresponding one of the plurality of applications.

4. The method of claim 1, further comprising, for a given one of the one or more additional computer systems, executing thereon a plurality of services, wherein the selected services on the given one of the one or more additional computer services comprise a subset of the plurality of services.

5. The method of claim 4, further comprising selecting the selected services from the plurality of services based on a list designating services of the selected services as critical services for an application.

6. The method of claim 5, further comprising compiling the list designating services of the selected services as critical services based on or more parameters, the one or more parameters including a determination as to whether the service is configured to automatically restart.

7. The method of claim 5, further comprising compiling the list of designated services of the selected services based on a list of applications corresponding to the selected services.

8. The method of claim 1, wherein the first computer system is located remotely with respect to the one or more additional computer systems.

9. The method of claim 1, further comprising querying one or more directories of each of the one or more additional computer systems to determine respective locations of the selected services.

10. The method of claim 1, wherein the mapping further comprises mapping one or more dependencies for each of the selected services.

11. The method of claim 1, further comprising storing information from the return data file into a database, wherein the database comprises a configuration management database.

12. The method of claim 1, further comprising monitoring, using an observability tool and data from the data file, one or more computers coupled to the network.

13. A non-transitory computer readable medium storing instructions thereon that, when executed by a first computer system, cause the first computer system to carry out operations comprising:
cause execution of a plurality of commands to access one or more additional computer systems;
determining, in response to executing the commands, selected services executing on each of one or more additional computer systems coupled, via a network, to the first computer system, wherein the selected services are accessed on a given one of the one or more additional computer systems without utilizing an agent executing on the given one of the one or more additional computer systems;
mapping each of the selected services to a corresponding one of a plurality of applications and a version number of the corresponding one of the plurality of applications;
updating, on the first computer system, a return data file having a plurality of entries, wherein entries of the return data file include identification of one of the selected services, a one of the one or more additional computers systems upon which the one of the selected services are executing, and a one of the plurality of applications and version number associated with the one of the selected services; and
displaying, on a dashboard, information from one or more of the entries of the return data file.

14. A networked computer system, comprising:
a plurality of services computer systems executing a plurality of applications running a plurality of computer services; and
a monitoring computer system including a display device including a graphical user interface (GUI) and one or more processors coupled to each services computer system and programmed to execute an algorithm including the steps of:
accessing each services computer system and determining selected services executing on each services computer system, wherein the selected services are accessed on a corresponding services computer system without utilizing an agent executing on the corresponding services computer system;
mapping each of the selected services to a corresponding one of a plurality of applications and a version number of the corresponding one of the plurality of applications;
updating a return data file stored on the monitoring computer system and having a plurality of entries, wherein entries of the return data file include identification of one of the selected services, a one of the services computer systems upon which the one of the selected services are executing, and a one of the plurality of applications and version number associated with the one of the selected services; and
rendering a monitoring dashboard on the monitoring computer system GUI displaying a number of user selectable application icons arranged in a grid, with each application icon representing an application running on the plurality of services computer systems.

15. The networked computer system of clam 14, wherein the one or more processors is programmed to execute the algorithm including the steps of:
receiving a user selection of one of the application icon associated with a corresponding application and responsively displaying an information icon indicating a corresponding service associated with the corresponding application, a version number of the corresponding application, corresponding services computer systems running the corresponding application, and status of the corresponding service on each of the corresponding services computer system indicating a current operation of the corresponding service.

16. The networked computer system of clam 14, wherein the status of the corresponding service indicates if the corresponding service is running and if the corresponding service is configured for automatic startup.

17. The networked computer system of clam 16, wherein the one or more processors is programmed to execute the algorithm including the steps of:
receiving a user selection of an application icon indicating the corresponding service is not running and responsively transmitting a restart signal to the corresponding services computer system running the corresponding application.

18. The networked computer system of clam 14, wherein the one or more processors is programmed to execute the algorithm including the steps of:
mapping each of the selected services to a vendor for the corresponding one of the plurality of applications; and
displaying each user selectable application icon with an image of the vendor.

19. The networked computer system of clam 17, wherein the one or more processors is programmed to execute the algorithm including the steps of:
rendering the monitoring dashboard to display user selectable application icons associated with the services included in a listing of services designated as critical services stored in the return data file.

20. The networked computer system of clam 16, wherein the one or more processors is programmed to execute the algorithm including the steps of:
querying one or more directories of each services computer system to determine respective IP address locations of the selected services; and
updating corresponding entries in the return data file to include the respective IP address locations.
